(19) United States
(12) Patent Application Publication
(10) Pub. No.: US 2016/0109295 A1
(43) Pub. Date: Apr. 21, 2016

(54) PORTABLE ELECTRONIC APPARATUS, SPECTROMETER COMBINED THEREWITH, AND METHOD FOR DETECTING QUALITY OF TEST OBJECT BY USING THE SAME

(71) Applicant: Guide Wang, Hsinchu City (TW)

(72) Inventor: Guide Wang, Hsinchu City (TW)

(21) Appl. No.: 14/919,481

(22) Filed: Oct. 21, 2015

(30) Foreign Application Priority Data
Oct. 21, 2014 (TW) 103136249

(51) Int. Cl. G01J 3/44; G01J 3/02

(52) U.S. Cl. CPC G01J 3/4412; G01J 3/0272

(57) ABSTRACT

A portable electronic apparatus, a spectrometer combined with the portable electronic apparatus, and a method for detecting quality of an object using the portable electronic apparatus are provided. The portable electronic apparatus includes a laser unit emitting an invisible-light laser light wave onto a surface of a test object to generate Raman scattered light, a grating diffracting the Raman scattered light, a camera lens built-in with an invisible-light filter to capture the diffracted Raman scattered light without the invisible-light laser light wave, a photoreceptor unit forming image information according to the Raman scattered light captured by the camera lens, and a processing unit obtaining a spectrum of the test object according to the image information. The portable electronic apparatus can quickly get the spectrum of the test object so as to detect the quality of the test object.

### BACKGROUND OF THE INVENTION

1. Field of the Invention

The present disclosure relates to a technique for detecting quality of a test object by using a portable electronic apparatus, and, more particularly, to a portable electronic apparatus, a spectrometer combined therewith, and a method for detecting quality of a test object by using the same.

2. Description of the Prior Art

Nowadays, people pay more attention on their life quality and health. Therefore, they concern more about safety of goods which contact with people around the environment or their daily life.

So far, the detection standards of goods, such as food, toys, 3C products, other daily commodities and so on, are performed by a chemical method. However, to employ such method, a qualified examiner has to perform a field sampling and take the sample to a laboratory for further examination. The suitable examination result will finally be obtained after complicated and lengthy examination processes. Therefore, traditional examination methods need professional examiners and have a high threshold in operation. Also, it is time consuming and costly.

Moreover, during the process such as manufacture, transportation, and marketing, the manufacturer or relevant associates will need to ensure the authenticity and quality of products in every stage, and therefore spend a lot of time and personnel costs. In addition, consumers cannot check the authenticity and quality by themselves. Hence, it will be more difficult to identify whether the product is fake, metamorphic, or changed.

Therefore, there is a need for overcoming the conventional technical problems mentioned above.

### SUMMARY OF THE INVENTION

The present disclosure provides a portable electronic apparatus, comprising a laser unit, a grating, a camera lens, a photoreceptor, and a processing unit. The laser unit emits an invisible-light laser light wave onto a surface of a test object to generate Raman scattered light. The grating diffracts the Raman scattered light generated from the surface of the test object. The camera lens is connected to the grating to capture the diffracted Raman scattered light. The photoreceptor is connected to the camera lens to form image information according to the Raman scattered light captured by the camera lens. The processing unit obtains a spectrum of the test object according to the image information of the test object.

The present disclosure further provides a spectrometer comprising a laser unit and a portable electronic apparatus. The laser unit emits an invisible-light laser light wave onto a surface of a test object to generate Raman scattered light. The portable electronic apparatus receives the Raman scattered light. The portable electronic apparatus comprises a grating, a camera lens, a photoreceptor, and a processing unit. The grating diffracts the Raman scattered light generated from the surface of the test object. The camera lens is connected to the grating to capture the diffracted Raman scattered light. The photoreceptor is connected to the camera lens to form image information according to the Raman scattered light captured by the camera lens. The processing unit obtains a spectrum of the test object according to the image information of the test object.

The present disclosure further provides a method for detecting quality of a test object by using a portable electronic apparatus. In one embodiment, the method comprises: providing an object code and a first spectrum of a test object from a first terminal; transmitting the test object from the first terminal to a second terminal to transmit the object code and the first spectrum of the test object to the second terminal or a database; capturing a second spectrum of the test object by the second terminal using the portable electronic apparatus, wherein the portable electronic apparatus emits an invisible-light laser light wave onto a surface of the test object to generate Raman scattered light, and diffracts the Raman scattered light to obtain the diffracted Raman scattered light and form image information according to the diffracted Raman scattered light to obtain the second spectrum of the test object; and determining a difference value between the second spectrum captured by the portable electronic apparatus and the first spectrum transmitted to the second terminal or to the database according to the object code, and detecting quality of the test object according to the difference value.

The present disclosure further provides a method for detecting quality of a test object using a portable electronic apparatus, comprising: providing a test object and an object code of the test object; capturing a first spectrum of the test object by the portable electronic apparatus, wherein the portable electronic apparatus emits an invisible-light laser light wave onto a surface of the test object to generate Raman scattered light, and diffracts the Raman scattered light from the surface of the test object to obtain the diffracted Raman scattered light and form image information according to the diffracted Raman scattered light to obtain the first spectrum of the test object; transmitting the first spectrum of the test object to a database by the portable electronic apparatus, wherein the database is stored with the object code of the test object and a second spectrum corresponding to the object code; and determining a difference value between the first spectrum captured by the portable electronic apparatus and the second spectrum stored in the database according to the object code, and detecting the quality of the test object according to the difference value.

According to the present disclosure, regarding the portable electronic apparatus, the spectrometer combined therewith, and the method for detecting the quality of a test object using the portable electronic apparatus according to the present disclosure, various elements, such as a laser unit, a grating, a camera lens, a photoreceptor, and a processing unit are configured in a portable electronic apparatus or a spectrometer, to sequentially obtain Raman scattered light and image information generated by the test object through emitting an invisible-light laser light wave onto a surface of the test object, and then obtain the spectrum of the test object rapidly.

Accordingly, the present disclosure can employ the portable electronic apparatus in a method for detecting the quality of a test object for the second terminal to determine the difference value between the second spectrum captured by the second terminal and the first spectrum provided by the first spectrum, or for consumers to determine the difference value between the spectrum captured by themselves and the spectrum store in database, so as to further detect the authenticity and quality of the test object without expensive examination equipment, a complicated examination procedure, a professional examiner, a high threshold operation technique, valuable time and costs.

### BRIEF DESCRIPTION OF THE DRAWINGS

FIG. 1 illustrates a schematic block diagram of a portable electronic apparatus according to the present disclosure;

FIG. 2 illustrates a schematic block diagram of a spectrometer combined with a portable electronic apparatus according to the present disclosure;

FIG. 3 illustrates a flow chart of a first embodiment of a method for detecting the quality of a test object according to the present disclosure; and

FIG. 4 illustrates a flow chart of a second embodiment of a method for detecting the quality of a test object according to the present disclosure.

### DETAILED DESCRIPTION OF THE PREFERRED EMBODIMENTS

The following illustrative embodiments are provided to illustrate the disclosure according to the present invention, these and other benefits and effects can easily be understood by those skilled in the art according to the disclosure of this specification.

It should be understood that the structure, proportion, and size depicted in the drawings are only intended to illustrate the disclosure of the specification to facilitate the understanding and reading for those skilled in the art, but not intended to limit the present disclosure in a specific condition. Any modification of the structure, change of the ratio relation, or adjustment of the size should be involved in the scope of the disclosure in this specification without influencing the producible efficacy and the achievable objective of this specification.

In this specification, the terminology used herein such as “upper,” “first,” “second,” and “surface,” are only for the purpose for convenience to describe, and is not intended to limit the scope of the invention. The changes or adjustments of relative relationship without substantial change of the technical content should also be considered within the category of implementation according to the present disclosure.

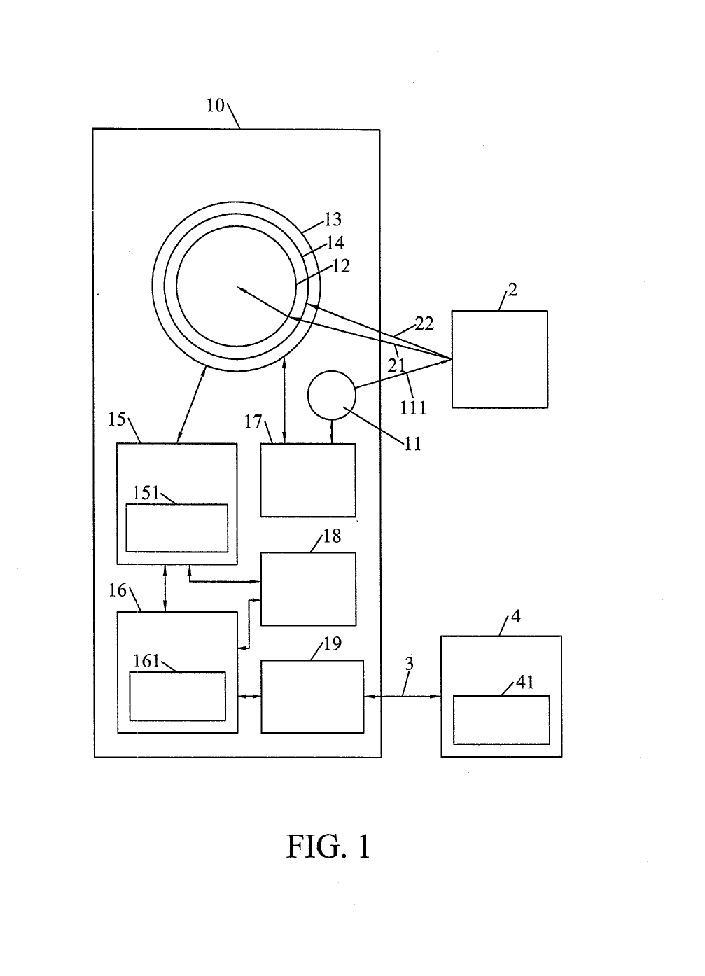

FIG. 1 illustrates a schematic block diagram of a portable electronic apparatus 10 according to the present disclosure. The portable electronic apparatus 10 comprises a laser unit 11, a grating 12, a camera lens 13, a photoreceptor 15, and a processing unit 16. In an embodiment, the portable electronic apparatus 10 is a smart phone, a tablet computer, or a laptop.

The laser unit 11 emits an invisible-light laser light wave 111 onto a surface of a test object 2 to generate Raman scattered light 21 from the surface of the test object 2 by the laser light wave 111. In an embodiment, the laser unit 11 emits ultraviolet light laser or infrared light laser, and the test object 2 is a homogeneous or heterogeneous distribution object, such as food, toys, 3C products, and daily commodities. It can be understood that the test object 2 having homogeneous distribution will have a better detection effect.

The grating 12 diffracts the Raman scattered light 21 generated from the surface of the test object 2. The camera lens 13 can be connected or attached to the grating 12, to capture the Raman scattered light 21 diffracted by the grating 12. In an embodiment, the camera lens 13 is a digital camera lens.

The photoreceptor 15 is connected to the camera lens 13 to form image information 151 according to the Raman scattered light 21 captured by the camera lens 13. In an embodiment, the photoreceptor 15 is a charge coupled device (CCD).

The processing unit 16 is connected to the photoreceptor 15 to calculate the light intensity of the Raman scattered light 21 in different wavelengths according to data of the image information 151 formed by the photoreceptor, to obtain a first spectrum 161 of the test object 2. The processing unit 16 can be a processor or a processing program.

The portable electronic apparatus 10 can further comprise an invisible-light filter 14, which is built-in or combined with the camera lens 13. After the laser unit 11 emits the laser light wave 111 onto the surface of the test object 2, the filter 14 filters out reflective light 22 generated from the surface of the test object 2, such that the diffracted Raman scattered light 21 will not contain invisible-light laser light.

The portable electronic apparatus 10 can further comprise an operating unit 17. The operating unit 17 can be connected to and control the laser unit 11 to emit the laser light wave 111, or be connected to and control the camera lens 13 to capture the Raman scattered light 21. In an embodiment, the operating unit 17 is a touch screen, a keyboard, or a button.

The portable electronic apparatus 10 can further comprises a display unit 18. The display unit 18 can be connected to the photoreceptor 15 to display the image information 151, or be connected to the processing unit 16 to display the first spectrum 161. In an embodiment, the display unit 18 is a screen.

The portable electronic apparatus 10 can further comprises a transceiving unit 19. The transceiving unit 19 can be connected to the processing unit 16 and transmit the first spectrum 161 to a database 4 through a wired or wireless network 3, or obtain a second spectrum 41 corresponding to the test object 2 from the database 4. In an embodiment, the transceiving unit 19 is a transceiver or antenna, and the database 4 is a big data database, a spectrum database, a cloud database, or an internet database.

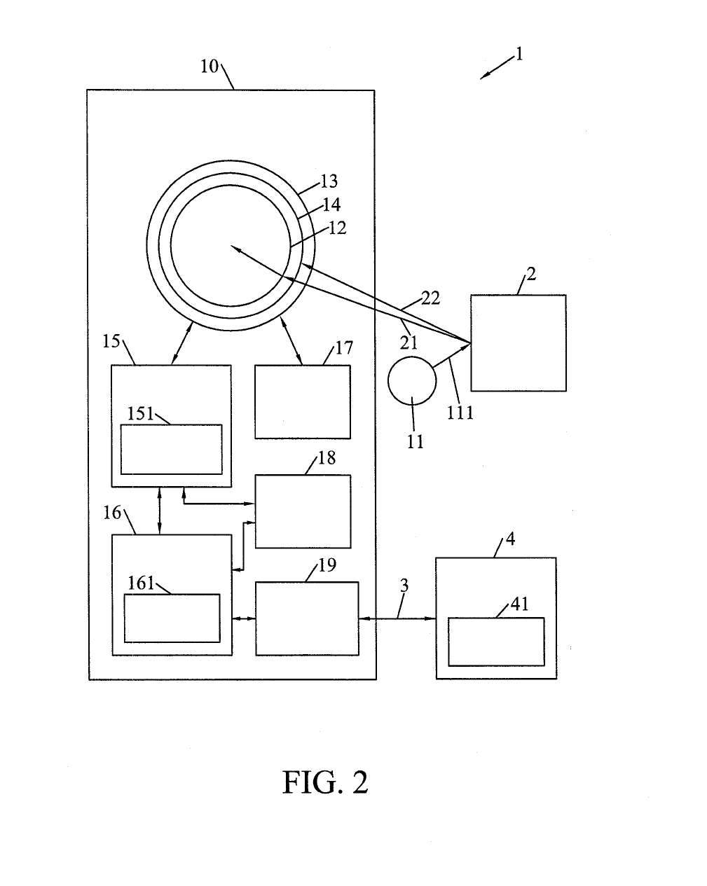

FIG. 2 illustrates a schematic block diagram of a spectrometer 1 combined with a portable electronic apparatus 10 according to the present disclosure. The spectrometer 1 shown in FIG. 2 is similar with the portable electronic device 10 shown in FIG. 1, and the main difference is described as follows.

In the spectrometer 1 shown in FIG. 2, a laser unit 11 is disposed in a region outside of the portable electronic apparatus 10 to emit an invisible-light laser light wave 111 onto a surface of a test object 2 to generate Raman scattered light 21 from the surface of the test object 2. Also, the laser unit 11 can have an operating element (not shown), such as a keyboard or a button, or be connected to and controlled by an operating unit. The spectrometer 1 can be a Raman spectrometer and so on. In an additional embodiment, the portable electronic apparatus 10 is used for receiving the Raman scattered light 21.

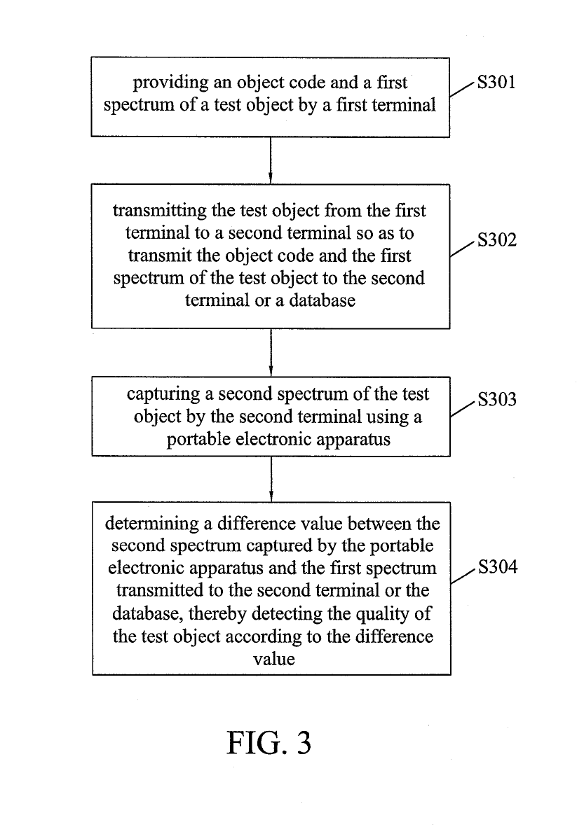

FIG. 3 illustrates a flow chart of a first embodiment of a method for detecting the quality of a test object according to the present disclosure.

As shown in step S301, an object code of a test object and a first spectrum corresponding to the object code are provided by a first terminal, and the first terminal can obtain the first spectrum of the test object by a first portable electronic apparatus or a spectrometer.

The first terminal can be a production terminal, a manufacture terminal, a transportation terminal and so on, and the test object can be a homogeneous or heterogeneous distributed object such as food, toys, 3C products, daily commodities, and so on. The object code can be a serial number or a barcode, and the barcode can be a one-dimensional barcode, a two-dimensional barcode, or a QR code.

The first portable electronic apparatus or the spectrometer can comprise the laser unit, the grating, the camera lens, the photoreceptor, and the processing unit, as shown in FIGS. 1 and 2, to emit an invisible-light laser light wave onto the surface of the test object to generate predetermined Raman scattered light, and further diffract the Raman scattered light to obtain the diffracted Raman scattered light, to form image information according to the diffracted Raman scattered light to obtain the first spectrum of the test object. The first portable electronic apparatus can be a smart phone, a tablet computer, or a laptop, and the spectrometer can be a Raman spectrometer. The laser unit can emit ultraviolet light laser or infrared light laser. The method proceeds to step S302.

As shown in step S302, the test object is transmitted from the first terminal to a second terminal through a distribution channel (such as a physical channel and a virtual channel) or logistics, to transmit the object code of the test object and the first spectrum to the second terminal or a database. More specifically, the first terminal can transmit the object code of the test object, the first spectrum, and the test object to the second terminal or to the database through a wired or wireless network. The second terminal can be a consumer terminal or a detection terminal, and the database can be a spectrum database, a cloud terminal, or an internet database. The method proceeds to step S303.

As shown in step S303, the second terminal uses a second portable apparatus to capture a second spectrum of the test object according to the object code of the test object.

More specifically, the second portable electronic apparatus can comprise the laser unit, the grating, the camera lens, the photoreceptor, and the processing unit as shown in FIG. 1, to emit an invisible-light laser light wave onto the surface of the test object to generate Raman scattered light, and further diffract the Raman scattered light to obtain the diffracted Raman scattered light, to form image information according to the diffracted Raman scattered light to obtain a second spectrum of the test object. In an embodiment, the camera lens of the second portable electronic apparatus can be built-in with an invisible-light filter to filter out the reflective light generated from the surface of the test object, such that the diffracted Raman scattered light will not contain invisible light laser light wave. The second portable electronic apparatus can be a smart phone, a tablet computer, or a laptop. The method proceeds to step S304.

As shown in step S304, a difference value between the second spectrum captured by the second portable electronic apparatus and the first spectrum transmitted to the first second terminal or the database by the second terminal is determined, so as to detect authenticity and quality of the test object according to the difference value. The second portable electronic apparatus can comprise a processor or a processing program (such as a comparing program or a detecting program), to determine the difference value between the first spectrum and the second spectrum, so as to detect authenticity and quality of the test object according to the difference value.

For example, when the difference value between the first spectrum and the second spectrum is equal to zero or within a predetermined error range, namely, the second spectrum is equal to or similar to the first spectrum, the test object is authentic, not fake, not metamorphic, or not changed. In contrast, when the difference value between the second spectrum and the first spectrum is not equal to zero or beyond the predetermined error range, namely, the second spectrum is not equal to or not similar to the first spectrum, the test object may be fake, metamorphic, or changed, and should be further determined by instrument with higher accuracy.

Therefore, with the method for detecting quality according to the first embodiment and by using an End-to-End detection method, the first terminal (such as a manufacture terminal) and the second terminal (such as a consumer terminal) can detect and identify authenticity and quality of the test object. Accordingly, there is no need to repeatedly detect authenticity and quality of the test object in every stage during the processes including production, transportation, and marketing, thereby saving time and personnel costs. If the consumers can test the test object by themselves, authenticity of the test object can be confirmed, and can prevent from the dilemma. For example, the attachment of the object is real, but the object is fake.

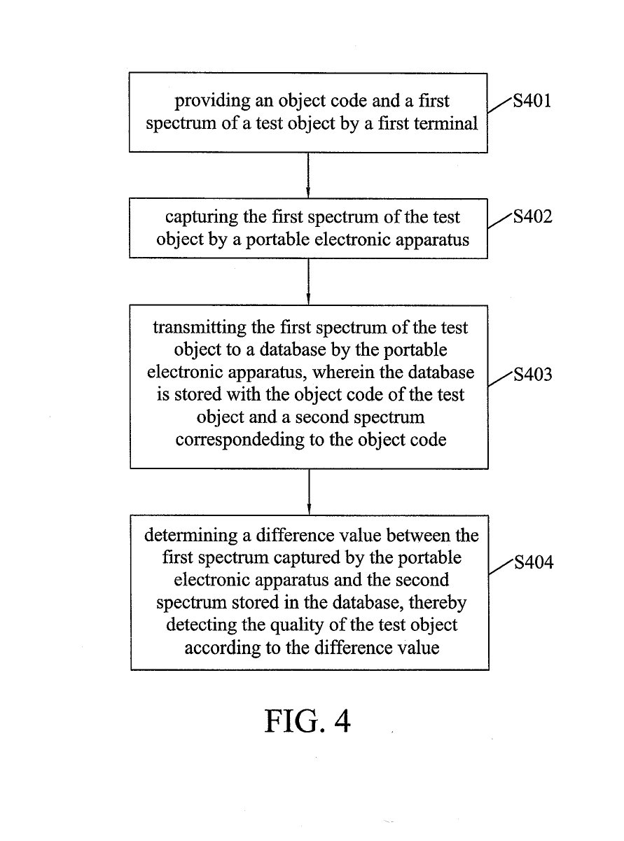

FIG. 4 illustrates a flow chart of a second embodiment of a method for detecting the quality of a test object according to the present disclosure. The elements depicted in FIG. 4 are almost the same as the elements depicted in FIG. 3. Similar descriptions of these elements are hereby omitted.

As shown in step S401, a test object or an object code can be provided, bought, or obtained by a consumer. The method proceeds to step S402.

As shown in step S402, the consumer can capture a first spectrum of the test object by the portable electronic apparatus. More particularly, the portable electronic apparatus can emit an invisible-light laser light wave onto a surface of a test object to generate predetermined Raman scattered light, and further diffracts the Raman scattered light to obtain the diffracted Raman scattered light, to form image information according to the diffracted Raman scattered light to obtain a first spectrum of the test object. The camera lens of the portable electronic apparatus is built-in with an invisible-light filter to filter out the reflective light generated from the surface of the test object, such that the diffracted Raman scattered light will not contain an invisible-light laser light wave. The method proceeds to step S403.

As shown in step S403, the first spectrum of the test object is transmitted to the database by the consumer using the portable electronic apparatus, and the database stores with the object code of the test object and a second spectrum corresponding to the object code. The database may be, but not limited to, a big data database, a spectrum database, a cloud database, and an internet database, and the second spectrum of the test object can be uploaded to the database by a plurality of consumers for further processing. The method proceeds to step S404.

As shown in step S404, the difference value between the first spectrum captured by the portable electronic apparatus and the second spectrum stored in the database by the consumer according to the object code is determined, and thereby authenticity and quality of the test object can be detected according to the difference value. Alternatively, whether the test object and the object detected by other consumers are the same is also detected. If they are different, the object of the consumer may have some problems, or the object of other consumers may have some problems.

The portable electronic apparatus can comprise a processor or a processing program (such as a comparing program or a detecting program) for determining the difference value between the first spectrum and the second spectrum. Consumers can detect authenticity and quality of the test object according to the difference value, or identify whether the test object and the object of other consumers are the same. If they are different, the object of the consumer may have some problems, or the object of other consumers may have some problems.

For example, when the difference value between the first spectrum captured by the consumer and the second spectrum uploaded by other consumers is equal to zero or within a predetermined error range, namely, the first spectrum is equal to or similar to the second spectrum, the quality of the test object of the consumer is equal to or similar to the object information uploaded by other consumers. In contrast, when the difference value between the first spectrum and the second spectrum is not equal to zero or beyond the predetermined error range, namely, the first spectrum is not equal to or not similar to the second spectrum, the quality of the test object of the consumer is not equal to or not similar to the object information uploaded by other consumers.

Therefore, according to the method for detecting quality of a test object of the second embodiment, the consumer can detect whether the quality of the test object is equal to the object information uploaded by other consumers by themselves using the portable electronic apparatus. Therefore, there is no need to repeatedly detect authenticity and quality of the test object in every stage during the process such as production, transportation, and marketing, thereby saving time and labor costs.

Accordingly, regarding a portable electronic apparatus, a spectrometer combined with a portable electronic apparatus, and a method for detecting the quality of a test object using a portable electronic apparatus according to the present disclosure, various elements, such as a laser unit, a grating, a camera lens, a photoreceptor, and a processing unit, are disposed within the portable electronic apparatus and the spectrometer, and configured to sequentially obtain Raman scattered light and image information generated by emitting an invisible-light laser light wave onto a surface of the test object, thereby obtaining the spectrum of the test object rapidly.

Accordingly, the present disclosure can be applied to the portable electronic apparatus in a method for detecting the quality of a test object, for a second terminal to determine a difference value between the spectrum captured by itself and a spectrum provided by a first terminal, or for consumers to determine a difference value between a spectrum captured by themselves and a spectrum stored in an external database, so as to further detect the authenticity and quality of the test object without expensive examination equipment, a complicated examination procedure, a professional examiner, a high threshold operation technique, valuable time and costs in conventional techniques.

The above exemplary embodiments are only intended to illustrate the principles and functions according to the present disclosure, but not to limit the present disclosure. One having ordinary skill in the art can perform modification and adaptation of the aforesaid embodiments without departing from the spirit and scope of the premise according to the present disclosure. Therefore, it is intended that the scope of the invention be defined by the claims appended hereto.

What is claimed is:

1. A portable electronic apparatus, comprising:
a laser unit emitting an invisible-light laser light wave onto a surface of a test object so as for the surface of the test object to generate Raman scattered light;
a grating diffracting the Raman scattered light generated from the surface of the test object;
a camera lens connected to the grating and capturing the Raman scattered light diffracted by the grating;
a photoreceptor connected to the camera lens and configured to form image information according to the Raman scattered light captured by the camera lens; and
a processing unit connected to the photoreceptor and configured to obtain a spectrum of the test object according to the image information formed by the photoreceptor.

2. The portable electronic apparatus of claim 1, further comprising an invisible-light filter combined with the camera lens, wherein the invisible-light filter filters out reflective light from the surface of the test object.

3. The portable electronic apparatus of claim 1, wherein the processing unit calculates light intensity of the Raman scattered light in different wavelengths according to data of the image information formed by the photoreceptor to obtain the spectrum of the test object.

4. The portable electronic apparatus of claim 1, further comprising an operating unit, a display unit and a transceiving unit, wherein the operating unit is connected to and configured to control the laser unit or the camera lens, the display unit is connected to the photoreceptor or the processing unit and configured to display the image information or the spectrum, respectively, and the transceiving unit is connected to a database and configured to transmit the spectrum to a database through internet or obtain the spectrum corresponding to the test object from the database.

5. The portable electronic apparatus of claim 1, wherein the laser unit emits ultraviolet light laser or infrared light laser.

6. The portable electronic apparatus of claim 1, being a smart phone, a tablet computer, or a laptop.

7. A spectrometer, comprising:
a laser unit emitting an invisible-light laser light wave onto a surface of a test object so as for the surface of the test object to generate Raman scattered light; and
a portable electronic apparatus receiving the Raman scattered light generated from the surface of the test object, the portable electronic apparatus comprising:
a grating diffracting the Raman scattered light generated from the surface of the test object;
a camera lens connected to the grating and capturing the Raman scattered light diffracted by the grating;
a photoreceptor connected to the camera lens and configured to form image information according to the Raman scattered light captured by the camera lens; and
a processing unit connected to the photoreceptor and configured to obtain a spectrum of the test object according to the image information formed by the photoreceptor.

8. The spectrometer of claim 7, wherein the portable electronic apparatus further comprises an invisible-light filter combined with the camera lens.

9. The spectrometer of claim 8, wherein the invisible-light filter filters out reflective light from the surface of the test object.

10. The spectrometer of claim 7, wherein the processing unit calculates light intensity of the Raman scattered light in different wavelengths according to data of the image information formed by the photoreceptor to obtain the spectrum of the test object.

11. The spectrometer of claim 7, wherein the portable electronic apparatus further comprises an operating unit, a display unit and a transceiving unit, and wherein the operating unit is connected to and configured to control the laser unit or the camera lens, the display unit is connected to the photoreceptor or the processing unit and configured to display the image information or the spectrum, respectively, and the transceiving unit is connected to a database and configured to transmit the spectrum to the database through internet or obtain the spectrum corresponding to the test object from the database.

12. The spectrometer of claim 7, wherein the laser unit emits ultraviolet light laser or infrared light laser.

13. The spectrometer of claim 7 being a Raman spectrometer.

14. The spectrometer of claim 7, wherein the portable electronic apparatus is a smart phone, a tablet computer, or a laptop.

15. A method, comprising:
providing an object code and a first spectrum of a test object by a first terminal;
transmitting the test object from the first terminal to a second terminal to transmit the object code and the first spectrum of the test object to the second terminal or a database;
capturing a second spectrum of the test object by the second terminal using a portable electronic apparatus, wherein the portable electronic apparatus emits an invisible-light laser light wave onto a surface of the test object to generate Raman scattered light, diffracts the Raman scattered light generated from the surface of the test object, and captures the diffracted Raman scattered light to form image information according to the diffracted Raman scattered light and obtain the second spectrum of the test object; and
determining a difference value between the second spectrum captured by the portable electronic apparatus and the first spectrum transmitted to the second terminal or to the database according to the object code, and detecting quality of the test object according to the difference value.

16. The method of claim 15, wherein the first terminal transmits the object code and the first spectrum of the test object along with the test object to the second terminal, or to the database through internet.

17. The method of claim 15, wherein the first terminal obtains the first spectrum of the test object by another portable electronic apparatus or a spectrometer.

18. The method of claim 17, wherein at least one of the portable electronic apparatus, the another portable electronic apparatus and the spectrometer comprises a laser unit, a grating, a camera lens, a photoreceptor and a processing unit.

19. A method, comprising:
providing a test object and an object code of the test object;
capturing a first spectrum of the test object by a portable electronic apparatus, wherein the portable electronic apparatus emits an invisible-light laser light wave onto a surface of the test object to generate Raman scattered light, diffracts the Raman scattered light generated from the surface of the test object, and captures the diffracted Raman scattered light to form image information according to the diffracted Raman scattered light and obtain the first spectrum of the test object;
transmitting the first spectrum of the test object to a database by the portable electronic apparatus, wherein the database is stored with the object code of the test object and a second spectrum corresponding to the object code; and
determining a difference value between the first spectrum captured by the portable electronic apparatus and the second spectrum stored in the database according to the object code, and detecting quality of the test object according to the difference value.

20. The method of claim 19, wherein the second spectrum is uploaded to the database by a plurality of consumers.
